(19) United States
(12) Patent Application Publication
(10) Pub. No.: US 2025/0206276 A1
(43) Pub. Date: Jun. 26, 2025

(54) POWER PRESSURE DEVICE WITH A CYLINDER CHAMBER

(71) Applicant: Robert Bosch GmbH, Stuttgart (DE)

(72) Inventor: Matthias Greiner, Simmozheim (DE)

(21) Appl. No.: 18/914,331

(22) Filed: Oct. 14, 2024

(30) Foreign Application Priority Data
Dec. 20, 2023 (DE) 10 2023 212 996.5

(51) Int. Cl. B60T 8/40; B60T 13/66

(52) U.S. Cl. CPC B60T 8/4022; B60T 8/4009; B60T 13/662

(57) ABSTRACT

A power pressure device. In the power pressure device, in particular for a hydraulic unit of a vehicle brake system, with a housing having a motor side for installing a motor driving the power pressure device and a control unit side, opposite the motor side, for installing a control unit controlling the motor, a cylinder arranged in the housing and extending with its cylinder axis from the motor side to the control unit side, and a piston axially displaceably guided in the cylinder and delimiting, with its piston end face, a cylinder chamber, the cylinder chamber is a first cylinder chamber and an additional second cylinder chamber is provided in the cylinder.

### CROSS REFERENCE

The present application claims the benefit under 35 U.S.C. § 119 of German Patent Application No. DE 10 2023 212 996.5 filed on Dec. 20, 2023, which is expressly incorporated herein by reference in its entirety.

### FIELD

The present invention relates to a power pressure device, in particular for a hydraulic unit of a vehicle brake system, with a housing having a motor side for installing a motor driving the power pressure device and a control unit side, opposite the motor side, for installing a control unit controlling the motor, a cylinder arranged in the housing and extending with its cylinder axis from the motor side to the control unit side, and a piston axially displaceably guided in the cylinder and delimiting, with its piston end face, a cylinder chamber. Furthermore, the present invention relates to the use of such a power pressure device in a hydraulic unit of a vehicle brake system.

### BACKGROUND INFORMATION

Some conventional brake systems are used in motor vehicles, such as motorcycles, cars, or trucks, to provide controlled brake pressure to associated wheel brakes, thus implementing slip controls. The core of such controllable brake systems is a hydraulic unit with hydraulic components, which are traditionally connected to a master brake cylinder. The master brake cylinder is to be actuated by a driver by means of a pedal and is used causally to generate the brake pressure on wheel brakes connected by brake lines. Hydraulic components to be controlled by means of a control unit, such as solenoid valves, sensors, and a pressure device usually to be operated electrically, are provided for controlling the brake pressure.

In today's brake systems, in particular in brake-by-wire brake systems, a power pressure device to be operated by means of the electric motor is used itself as a source of power for generating brake pressure on the wheel brakes. A brake pressure generated thereby is conducted to the wheel brakes by means of hydraulic or electromechanical actuators. In such a normal brake case, the master brake cylinder is decoupled from the wheel brakes and is used to detect the braking request of the driver. In the event of a failure of the source of power, the master brake cylinder provides a hydraulic fallback level, which the driver can actuate via the pedal.

Newer vehicle developments also allow for driving with increasing levels of automation, which places new demands on the brake system. In order for driver intervention to no longer be necessary, it must in particular be possible to generate pressure by means of a source of power in a particularly dependable and reliable manner.

It is an object of the present invention to provide a power pressure device, by means of which a particularly compact and cost-effective design for the generation of pressure is created, which is in particular also particularly reliable.

### SUMMARY

According to the present invention, a power pressure device is provided, in particular for a hydraulic unit of a vehicle brake system or brake system. According to an example embodiment of the present invention, the power pressure device includes presea housing or hydraulics housing having a motor side for installing a motor driving the power pressure device and a control unit side, opposite the motor side, for installing a control unit controlling the motor, a cylinder arranged in the housing and extending with its cylinder axis from the motor side to the control unit side, a piston axially displaceably guided in the cylinder and delimiting, with its piston end face, a cylinder chamber. The cylinder chamber is a first cylinder chamber, and an additional second cylinder chamber is provided in the cylinder. The second cylinder chamber is designed to be separate from the first cylinder chamber, in particular such that a pressure medium received in the first cylinder chamber does not come into contact with a pressure medium received in the second cylinder chamber.

Thus, with the second cylinder chamber according to the present invention between the motor side and the control unit side, a power cylinder is created, which comprises two cylinder chambers separate from one another, in particular in terms of pressure medium. From each cylinder chamber, a brake pressure on at least one associated wheel brake of an associated brake circuit can thus be generated. A brake pressure generated by means of the power pressure device can thus be conducted separately from one another into two brake circuits. A redundant mode of operation is made possible.

In addition, by means of the arrangement of the two cylinder chambers between the motor side and the control unit side, a particularly compact arrangement is achieved in the housing. The cylinder axis of the cylinder extends perpendicularly to the motor side or control unit side, which determines a Y-axis or Y direction. A housing thickness of the housing extends along the Y-axis and is preferably designed to be relatively narrow in comparison to a housing height extending along a Z-axis or to a housing length extending along an X-axis. The cylinder with its two cylinder chambers protrudes through this preferably narrow housing thickness. Preferably, the cylinder is lengthened depending on the volume requirement by means of a cup-shaped cylinder cover closing an associated cylinder opening on the control unit side. For the same purpose, the cylinder is preferably lengthened by means of a housing projection projecting from the control unit side. Particularly preferably, the cylinder with its cylinder axis is completely accommodated in the housing and, when more volume is required, either the housing thickness of the housing is adjusted or the diameter of the cylinder is increased accordingly. For more volume, compactly less space in the X and Z directions is necessary with an increased diameter than with an increased length in the Y direction.

In contrast, a traditional master brake cylinder, in particular one to be actuated by means of a pedal, is arranged in the housing with its axis parallel to the motor side, and thus axially in parallel with the X-axis or along the housing length. Preferably, in a space-saving and component-saving manner, such a master brake cylinder is not provided in the hydraulic unit associated with the power pressure device according to the present invention.

Rather, according to the present invention, the power pressure device is advantageously provided to be used in the hydraulic unit solely or exclusively to generate a brake pressure on at least one wheel brake of the associated brake system. That is to say, the power pressure device in the associated hydraulic unit and brake system is advantageously the only brake pressure generator. A very compact arrangement in the housing is thus achieved with only a single brake pressure generator, which extends axially through the housing from the motor side to the control unit side. In addition, the associated brake system is a true-brake-by-wire brake system. This significantly saves components, weight and costs.

Advantageously, in the power pressure device according to an example embodiment of the present invention, the second cylinder chamber is arranged axially downstream of the first cylinder chamber in the pressure direction of the piston. Such an axial arrangement of the two cylinder chambers is particularly compact and particularly simple to implement in terms of structural engineering. Alternatively, more complex arrangements in terms of structural engineering are possible, which are very compact in their design and can be used as required. Preferred is a radial arrangement of the two cylinder chambers, in which one cylinder chamber in particular radially encompasses the other cylinder chamber, or, alternatively preferably, an arrangement in which the two cylinder chambers are adjacent to one another.

In addition, according to an example embodiment of the present invention, a further piston coupled in a force-transmitting manner to the piston is advantageously arranged axially downstream of the piston in the pressure direction of the piston. The piston is thus a primary piston and the further piston is a secondary piston, which depends on a movement of the primary piston. The further piston is preferably coupled in a force-transmitting manner to the piston by means of a spring, wherein the spring is in particular arranged axially between the two pistons and preferably designed as a coil spring. Furthermore, the further piston is supported with a return spring, which is likewise preferably designed as a coil spring, on the cylinder. A conventional piston and support system from traditional tandem master brake cylinders is thus selected so that conventional cost-saving components can be used.

Furthermore, according to an example embodiment of the present invention, the piston is advantageously to be displaced axially by means of a screw drive drivable by the motor. A rotational movement of a motor shaft belonging to the motor is thus mechanically converted into a translational movement of the piston. An inverted conversion is also possible in a simple manner. For this purpose, the screw drive comprises a spindle with a thread as well as a nut which encompasses the spindle in a hollow cylindrical manner and engages in the thread. The piston can thus be moved in a very finely adjustable manner. Preferably, the screw drive or spindle drive is designed in a component-saving manner as a trapezoidal screw drive, in which the nut slides directly on a trapezoidal thread of the spindle. Particularly preferably, the spindle drive is designed to be very low friction as a ball screw drive, in which balls used as rolling bearings between the spindle and the nut are provided.

An advantage according to the present invention is that a first discharge line, by means of which a first brake circuit is to be supplied with pressure medium, extends from the first cylinder chamber and a second discharge line, by means of which a second brake circuit is to be supplied with pressure medium, extends from the second cylinder chamber. Both brake circuits belong to a modulation device, by means of which the brake pressure generated by means of the power pressure device on at least one wheel brake associated with the respective brake circuit is to be modulated for a slip control or an electronic stability program. The two discharge lines thus create a connection of the modulation device to an actuation device, to which the power pressure device advantageously belongs as the only brake pressure generator.

In addition, an advantage according to the present invention is that a first feed line, which is connected to a first reservoir chamber of a two-part reservoir, extends into the first cylinder chamber and a second feed line, which is connected to a second reservoir chamber of the two-part reservoir, extends into the second cylinder chamber, wherein a radial sealing element is in each case provided axially on both sides of each feed line, in particular along the cylinder axis. In particular, the sealing element is in each case arranged in a sealing groove or groove in an associated cylinder wall, radially projects from the sealing groove into the cylinder and radially encompasses the piston. By means of such a seal, a separation of the pressure medium of the two cylinder chambers is achieved. In addition, a separate supply of pressure medium is achieved by means of the two reservoir chambers, which are separated from one another and each exchange pressure medium with an associated cylinder chamber. Even in the case of a fault, such as a leakage of a pressure medium supply, a brake pressure can still be built up by means of the other pressure medium supply in the associated brake circuit on the at least one wheel brake associated therewith. In particular in combination with the two discharge lines, which each extend from a cylinder chamber into the respectively associated brake circuit, a brake circuit separation is achieved, by means of which a redundant brake system with two hydraulically separated brake circuits is created.

Advantageously, according to an example embodiment of the present invention, the motor is arranged on the motor side of the housing, the control unit is arranged on the control unit side of the housing, and a channel extending through the housing is arranged from the motor side to the control unit side. An electrical connection between the motor and the control unit extends through the channel. A compact and short control connection is thus provided through the housing thickness.

In addition, according to an example embodiment of the present invention, a pressure sensing device is advantageously provided, by means of which a pressure present in the first cylinder chamber and/or a pressure present in the second cylinder chamber is to be sensed. The pressure is in particular a pressure of the pressure medium located in the respective cylinder chamber. By sensing this pressure, pressure monitoring is in particular implemented, by means of which it can simultaneously be monitored whether the respectively associated sealing elements are still sufficiently tight. For this purpose, the pressure sensing device is preferably designed with a pressure sensor, which can simply be installed in the housing and directly read by means of electronics of a printed circuit board of the control unit. A particularly reliable power pressure device is thus created.

In addition, the present invention is also aimed at a use of such a power pressure device in a hydraulic unit of a vehicle brake system, wherein, in the hydraulic unit, a brake pressure is advantageously generated on at least one associated wheel brake exclusively by means of the power pressure device and a motor driving the power pressure device. In particular, according to an example embodiment of the present invention, the power pressure device belongs to an actuation device, by means of which the brake pressure is generated on at least one associated wheel brake.

Advantageously, according to an example embodiment of the present invention, in addition to the actuation device, the hydraulic unit comprises a modulation device, by means of which the generated brake pressure on the at least one associated wheel brake is modulated. The modulation device comprises a pump motor for driving at least one pump, by means of which the brake pressure generated by means of the power pressure device is modulated. The modulation device is a conventional electronic stability program system (ESP system).

Furthermore, the present invention is aimed at a use of such a power pressure device in a hydraulic unit of a vehicle brake system with a first and a second brake circuit for generating hydraulic pressure on at least one associated wheel brake in each case. Advantageously, a brake pressure is generated on the at least one first wheel brake and/or on the at least one second wheel brake solely by means of the power pressure device.

Accordingly, the present invention is also aimed at a hydraulic unit of a vehicle brake system and at a vehicle brake system, wherein the hydraulic unit and the vehicle brake system comprise the power pressure device designed in this way. The power pressure device is advantageously used solely or exclusively to generate a brake pressure so that no further pressure generator and, in particular, no pedal-actuatable master brake cylinder is provided. This creates a very compact hydraulic unit and a brake system, in particular without driver intervention, which makes increasingly autonomous driving with a high degree of safety possible.

Overall, the primary piston and, advantageously, the secondary piston as well as the advantageous spring and the advantageous sealing elements in the power pressure device according to the present invention are preferably constructed similarly to a conventional tandem master brake cylinder technology. In the best case scenario, required components are adopted from traditional pressure generation concepts. By utilizing conventional components and the thus achievable economies of scale, production costs can be saved to a large extent.

An exemplary embodiment of the solution according to the present invention is explained in detail below with reference to the figures.

### BRIEF DESCRIPTION OF THE DRAWINGS

FIG. 1 shows a schematic longitudinal section of an exemplary embodiment of a power pressure device according to the present invention.

FIG. 2 shows a hydraulic circuit diagram of a design variant of a vehicle brake system designed with the power pressure device according to FIG. 1.

### DETAILED DESCRIPTION OF EXAMPLE EMBODIMENTS

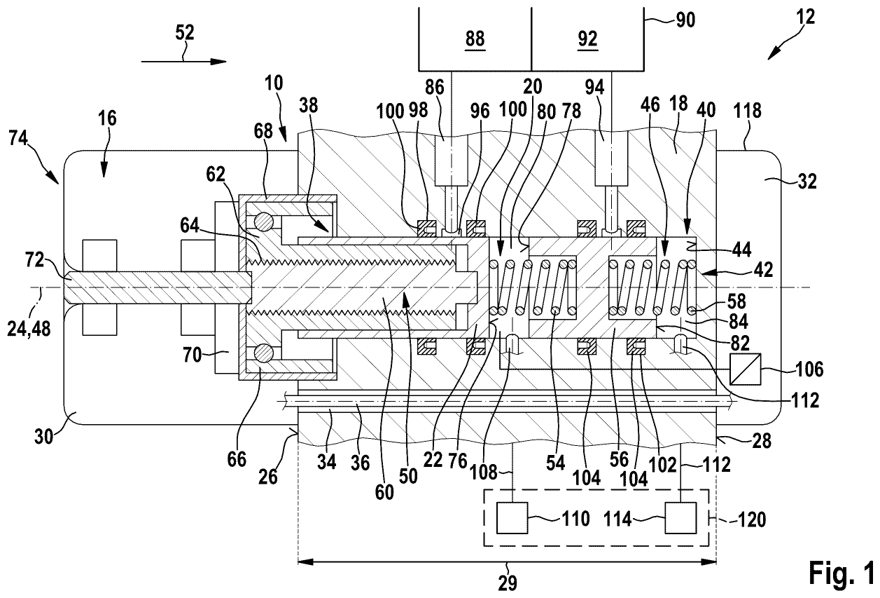

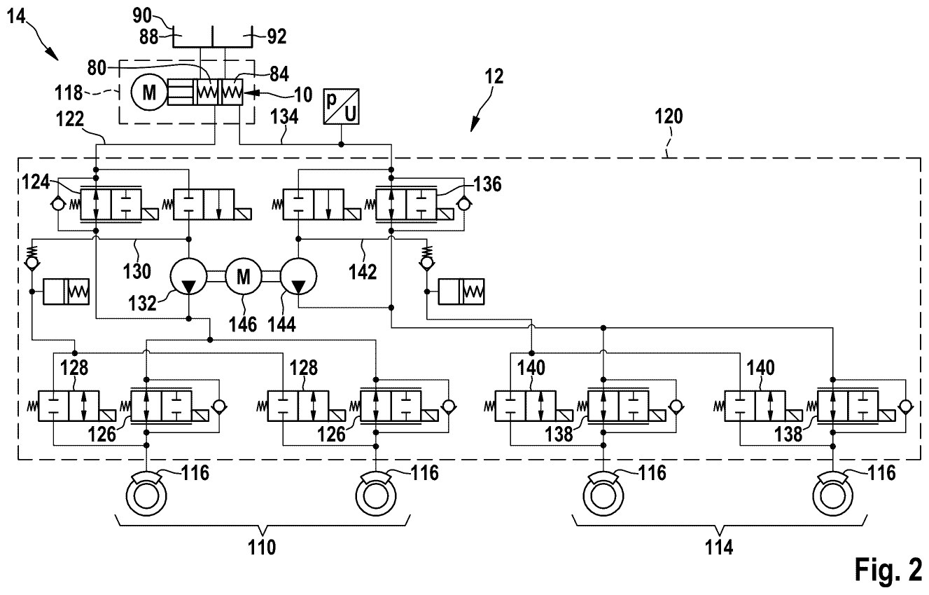

FIG. 1 illustrates a power pressure device 10 or pressure device 10 of a hydraulic unit 12 (shown in detail) for an electrohydraulic vehicle brake system 14 or brake system 14 shown schematically in FIG. 2. The brake system 14 is provided for a vehicle brake system of a four-wheeled vehicle not shown. By means of the brake system, functions of an anti-lock brake system (ABS), an electronic stability program (ESP) and/or an anti-slip control (ASR) are to be fulfilled.

The pressure device 10 is designed as a plunger device, which Is to be driven by a motor 16 designed as an electric motor. The motor 16 is conventional and shown only in highly schematic form. The motor 16 represents a power drive of the brake system and is thus part of a vehicle power brake system. The motor 16 belongs to the pressure device 10, which is thus used as a brake pressure generator for generating a brake pressure. The pressure device 10 is thus an extrinsic pressure source in the brake system 14, which in the present case is designed as a true-brake-by-wire brake system. In this case, a required energy for a brake pressure is provided solely by an associated external energy source.

In terms of structural engineering, the hydraulic unit 12 comprises a hydraulics housing 18 or housing 18 (shown only partially), which is designed as a hydraulic block. A channel 20 designed as a stepped bore is arranged in the housing 18. The channel 20 forms a power cylinder receptacle, which accommodates a piston 22, which is used as the power piston and designed as a plunger or plunger piston. Furthermore, the channel 20, with its channel axis 24 congruent with the piston axis, extends axially perpendicularly from a housing side used as the motor side 26 to an opposite housing side used as the control unit side 28. The channel axis 24 defines a Y-axis of a fictitious Cartesian coordinate system, along which the housing 18 with its housing thickness 29 extends between the motor side 26 and the control unit side 28. The motor 16 is arranged with its motor housing 30 on the motor side 26, and an electronic control unit 32 is arranged on the control unit side 28. Provided in parallel with the channel axis 24 Is a further channel 34, which is completely continuous from the motor side 26 to the control unit side 28 and has a diameter that is significantly smaller in cross-section than the channel 20. An electrical connection 36 coupling the control unit 32 and the motor 16 in a signal-transmitting manner to one another extends through the further channel 34.

The channel 20 is designed to be open at its first end 38, which faces the motor 16, and extends with its second end 40, which faces the control unit 32, at a distance 42 to the control unit side 28. At the distance 42, a cylinder bottom 44 of a cylinder 46, which is formed by the channel 20, with a cylinder axis 48 congruent with the channel axis 24 is thus provided. The cylinder 46 is here formed entirely by the channel 20. Alternatively, the cylinder 46 is formed with the channel 20 and a cup-shaped cylinder cover lengthening the channel 20 coaxially, or a housing projection lengthening the channel 20 coaxially (neither is shown).

The piston 22 is used as the first piston or primary piston and is designed to be cup-shaped as well as circular in cross-section and is to be moved axially back and forth by the motor 16 by means of a screw drive 50. Displacing the piston 22 into the cylinder 46 creates pressure in the cylinder 46 along a pressure direction 52. Axially downstream of the piston 22 in the pressure direction 52 of the piston 22, a further piston 56 is arranged, which is coupled in a force-transmitting manner to the piston 22 by means of a coaxially arranged spring 54 and is accordingly moved together with the first piston 22. The further piston 56 as the second piston or secondary piston is supported on the cylinder bottom 44 by means of a coaxially arranged return spring 58.

In addition, a spindle 60 is accommodated inside the cup-shaped first piston 22 and surrounded by a hollow cylindrical, thin-walled nut 62. On the outside, the nut 62 engages in a positive manner in a spindle thread 64 formed on the spindle 60. Furthermore, at the end face facing the motor 16, the nut 62 is surrounded by a pivot bearing 66, which is fixedly held on the outside by a cup-shaped bearing cover 68 fixedly coupled to the housing 18. The nut 62 rotatably mounted by means of the pivot bearing 66 is to be rotated by means of the motor 16, whereby this rotational movement via the spindle thread 64 results in a displacement of the spindle 60 and thus of the piston 22 in the cylinder 46. For this purpose, the spindle 60 is driven by a transmission 70, which is designed here as a planetary gear train and is coupled in a force-transmitting manner to a motor shaft 72 belonging to the motor 16. The motor shaft 72, the transmission 70, the spindle 60, and the nut 62, together with the motor 16, belong to an actuator 74, by means of which the piston 22 is selectively to be displaced back and forth in the cylinder 46 depending on the direction of rotation of the motor 16.

For this purpose, at its end opposite the actuator 74, the piston 22 has a piston end face 76, which, together with the housing 18, which surrounds the channel 20, and a piston end face 78 of the second piston 56 that faces the piston 22, delimits a first cylinder chamber 80. The second piston 56 is designed to be double-T-shaped in its longitudinal section. In detail, the piston end face 78 of the second piston 56 is cup-shaped and designed to be open toward the first piston 22. The spring 54, which is designed here as a coil spring, is partially axially accommodated with its outer circumference in this cup shape and is axially and radially supported there. Opposite the piston end face 78, a further cup-shaped piston end face 82, which is designed to be open toward the cylinder bottom 44, is located on the second piston 56. Accordingly, the return spring 58, which is likewise designed as a coil spring, is partially axially accommodated with its outer circumference as well as axially and radially supported in the cup shape there. The cylinder bottom 44, the housing 18, which surrounds the channel 20, and piston end face 82 delimit a second cylinder chamber 84, which is arranged axially downstream of the first cylinder chamber 80 in the pressure direction 52. The two cylinder chambers 80 and 84 are designed to be axially displaceable and changeable in their axial extent depending on the position of the associated two pistons 22 and 56.

The first cylinder chamber 80 is connected in a fluid-conducting and pressure-conducting manner to a first reservoir chamber 88 by means of a first feed line 86. The first reservoir chamber 88 belongs to a reservoir 90 used as a pressure medium storage container for compensatorily supplying pressure medium or brake fluid. Separated from the first reservoir chamber 88 in terms of pressure medium, a second reservoir chamber 92 is provided in the reservoir 90 and is connected in a fluid-conducting manner to the second cylinder chamber 84 by means of a second feed line 94. Preferably, the two feed lines 86 and 94 each protrude into a relatively small groove 96 arranged in the channel 20. Axially on both sides of the first feed line 86, an annular, radially circumferential sealing element 100 is in each case arranged in a respective, radially circumferential groove 98 arranged in the channel 20. Each sealing element 100 projects radially out of the groove 98 into the channel 20 and radially sealingly encompasses the first piston 22. Likewise, axially on both sides of the second feed line 94, an annular, radially circumferential sealing element 104 is in each case arranged in a respective, radially circumferential groove 102 and, accordingly, radially sealingly encompasses the second piston 56. The two associated cylinder chambers 80, 84 are thus each sealed toward one another and are thereby designed to be separated from one another in terms of pressure medium. A pressure sensing device 106 coupled to the first cylinder chamber 80 is provided for monitoring a tightness of the sealing elements 100, 104. The pressure sensing device 106 is designed as a pressure sensor and is connected in a signal-transmitting manner to the control unit 32.

Furthermore, a first discharge line 108 (only shown in a highly schematic form here) extends from the first cylinder chamber 80 in the pressure direction 52, close to the second piston 56. The first discharge line 108 is used to supply pressure medium from the first cylinder chamber 80 to a first brake circuit 110 of the brake system 14. Accordingly, a second discharge line 112 extends from the second cylinder chamber 84, close to the cylinder bottom 44, and is used to supply pressure medium to a second brake circuit 114 of the brake system 14.

During operation, as the first piston 22 and the second piston 56 coupled thereto move out of the cylinder 46, fluid is drawn through the feed lines 86, 94, which are used as intake lines, into the two cylinder chambers 80, 84. In this case, the cylinder chambers 80, 84 are used as suction chambers. As the first piston 22 and the second piston 56 coupled thereto move into the cylinder 46, the drawn fluid is pressurized, wherein the cylinder chambers 80, 84 are used as pressure chambers, by means of which the pressure for the brake system 14 is to be generated. From the cylinder chambers 80, 84, the fluid is displaced through the discharge lines 108, 112 into the respectively associated brake circuit 110, 114 in order to generate brake pressure on respectively associated wheel brakes 116. The pressure device 10 thus forms an actuation device 118 for causally generating brake pressure.

FIG. 2 shows that, in the associated brake system 14, the pressure device 10 is the only brake pressure generator in the actuation device 118. For modulating the generated brake pressure, an ESP system is connected as a modulation device 120 to the actuation device 118.

In detail, the first discharge line 108 is connected in a fluid-conducting manner to a first supply line 122 or corresponds to the first supply line 122 of the first brake circuit 110. Furthermore, a first control valve 124 or plunger control valve, which is designed as a normally open 2/2-way solenoid valve and can be closed as needed by applying current, is arranged in the first supply line 122. The first supply line 122 extends by means of a branched line section through two first inlet valves 126, which are arranged in parallel circuits, to a respectively associated wheel brake 116 in each case. The two wheel brakes 116 of the first brake circuit 110 are connected to a first pump 132 on the suction side by a respectively associated first outlet valve 128 with a common first return line 130. In this respect, the term “line” may also be understood to mean a branched or reunited line section.

Accordingly, in the second brake circuit 114, the second discharge line 112 is connected in a fluid-conducting manner to a second supply line 134, in which a normally open second control valve 136 is arranged. The second supply line 134 extends to two second inlet valves 138, which are each connected to a wheel brake 116. The two wheel brakes 116 of the second brake circuit 114 are connected to a common second return line 142 by a respectively associated second outlet valve 140 and thereby to a second pump 144 on the suction side. Furthermore, a pump motor 146, which is to drive the two pumps 132 and 144, is provided between the two brake circuits 110 and 114. By means of the pumps 132, 144 and the pump motor 146 as well as by means of a corresponding conventional circuit of the inlet valves 126, 138 and outlet valves 128, 140, the brake pressure generated by means of the pressure device 10 on the wheel brakes 116 is to be modulated as needed.

With the power pressure device 10 according to the present invention for a brake-by-wire brake system, an optimized brake pressure generator is thus created, which is combined with a standard modulation device 120 (ESP system) by means of the two hydraulic discharge lines 108, 112 and thus forms a redundant brake system 14. In particular, a particularly cost-optimized design is thus made possible, which utilizes components already available in series production, such as the motor 16, the pistons 22 and 56, the spring 54, the return spring 58 as well as the sealing elements 100, 104. In addition, the concept of the motor 16 on one side of the housing 18 and of the control unit 32 on the opposite control unit side 28 makes assembly on a uniform ESP assembly line possible. This significantly reduces the production costs since no specific investment is required.

What is claimed is:

1. A power pressure device for a hydraulic unit of a vehicle brake system, comprising:
a housing having a motor side for installing a motor driving the power pressure device, and a control unit side, opposite the motor side, for installing a control unit controlling the motor;
a cylinder arranged in the housing and extending with a cylinder axis from the motor side to the control unit side; and
a piston axially displaceably guided in the cylinder and delimiting, with a piston end face, a cylinder chamber;
wherein the cylinder chamber is a first cylinder chamber, and an additional second cylinder chamber is provided in the cylinder.

2. The power pressure device according to claim 1, wherein the power pressure device is provided to be used in the hydraulic unit solely to generate a brake pressure on at least one wheel brake of the vehicle brake system.

3. The power pressure device according to claim 1, wherein the second cylinder chamber is arranged axially downstream of the first cylinder chamber in a pressure direction of the piston.

4. The power pressure device according to claim 1, wherein a further piston coupled in a force-transmitting manner to the piston is arranged axially downstream of the piston in the pressure direction of the piston.

5. The power pressure device according to claim 4, wherein the further piston is coupled in a force-transmitting manner to the piston using a spring.

6. The power pressure device according to claim 1, wherein the piston is configured to be displaced axially by a screw drive drivable by the motor.

7. The power pressure device according to claim 1, wherein a first discharge line, using which a first brake circuit is supplied with pressure medium, extends from the first cylinder chamber, and a second discharge line, using which a second brake circuit is to be supplied with pressure medium, extends from the second cylinder chamber.

8. The power pressure device according to claim 1, wherein a first feed line, which is connected to a first reservoir chamber of a two-part reservoir, extends into the first cylinder chamber and a second feed line, which is connected to a second reservoir chamber of the two-part reservoir, extends into the second cylinder chamber, wherein a radial sealing element is in each case provided axially on both sides of each of the first and second feed lines, in particular along the cylinder axis.

9. The power pressure device according to claim 1, wherein a pressure sensing device is provided, using which a pressure present in the first cylinder chamber and/or a pressure present in the second cylinder chamber is sensed.

10. A method of using a power pressure device in a hydraulic unit of a vehicle brake system with a first brake circuit (110) and a second brake circuit for generating hydraulic pressure on at least one associated wheel brake in each case, wherein the first brake circuit includes a first supply line, to which at least one first wheel brake is to be connected, and the second brake circuit includes a second supply line, to which at least one second wheel brake is to be connected, and an electrically controllable power pressure device is provided, which is designed with a housing having a motor side, on which a motor driving the power pressure device is arranged, and a control unit side, which is opposite the motor side and on which a control unit configured to control the motor is arranged, the controllable power pressure device further including a cylinder, which is arranged in the housing and extends with its cylinder axis from the motor side to the control unit side, and includes a piston, which is axially displaceably guided in the cylinder and delimits, with a piston end face, a cylinder chamber filled with pressure medium, wherein the cylinder chamber is a first cylinder chamber filled with pressure medium, and an additional second cylinder chamber filled with pressure medium is provided in the cylinder, the method comprising:
selecting connecting the first cylinder chamber to the first supply line in a pressure-medium-conducting manner; and
selectively connecting the second cylinder chamber to the second supply line in a pressure-medium-conducting manner.

11. The method according to claim 10, wherein a brake pressure on the at least one first wheel brake and/or on the at least one second wheel brake is generated solely via the power pressure device.
